(19) United States
(12) Patent Application Publication
(10) Pub. No.: US 2013/0103522 A1
(43) Pub. Date: Apr. 25, 2013

(54) MOBILE DATA NETWORK

(71) Applicant: Stefan LODEWEYCKX, Leuven (BE)

(72) Inventor: Stefan LODEWEYCKX, Leuven (BE)

(73) Assignees: Sony Europe Limited, Weybridge (GB); Sony Corporation, Tokyo (JP)

(21) Appl. No.: 13/278,926

(22) Filed: Oct. 21, 2011

(51) Int. Cl. G06Q 30/06

(52) U.S. Cl. 705/26.1

(57) ABSTRACT

A mobile data network includes a data server that interacts with client devices via the internet and provides a price database and an online store. Mobile device and a mobile data connection are also included. An authorization system authorizes a data transfer between the mobile device and the data server, and generates data representative of a mobile data access charge for the data transfer. In a first mode of operation, the mobile device communicates with the data server and the data server accesses the price database to offer a set of digital content items at a first set or prices. In a second mode of operation, the data server accesses the price database to offer the set of digital content items at a second set of prices, different to the first set of prices.

### BACKGROUND

1. Field of the Invention

This invention relates to mobile data networks.

2. Description of the Prior Art

Mobile data communication devices, including so-called smart phones, tablet computers and other portable data handling devices (referred to here generically as user equipment or UE), are often arranged to access the Internet via a wireless data connection provided by a mobile data network. Such a mobile data network typically comprises an array of base stations geographically separated from one another, with the UE communicating with a nearby base station by a wireless signal. An example system currently in use is the so-called 3G LTE system.

Connection via a mobile data network can provide a great deal of flexibility to the user of the UE, in that data access can be possible from a wide variety of geographical locations. A disadvantage is that the costs of such data access are typically relatively high, and are generally significantly higher than the cost of accessing the Internet using a wireless (Wi-Fi) or wired connection to a broadband Internet service such as a domestic broadband service. Therefore, it is typical for users to prefer their UEs to implement a data connection by a local area network if one is available, and only to use a mobile data network if no local network is available.

The Blackberry® network operated by Research In Motion™ provides a differentiation between different types of data traffic relating to a UE. Some types of data traffic, in particular those which relate to e-mails or other messages transmitted over the Blackberry network, are carried “free of charge”, which is to say that the data costs associated with sending such messages over a mobile data network are absorbed by the mobile data network operator or the UE provider, possibly within a fixed monthly service charge associated with the particular UE using the Blackberry network, rather than being individually chargeable to the user of the UE. Other categories of data traffic are chargeable to the owner of the UE in the usual way.

It is an object of the invention to provide an improved user experience involving a device making use of a mobile data network to access the Internet or other services.

### SUMMARY OF THE INVENTION

This invention provides a mobile data network comprising:

a data server configured to interact with client devices via the internet, the data server providing a price database and an online store by which a set of digital content items are offered for download at a respective set of prices provided by the price database;

a mobile device;

a mobile data connection infrastructure providing a data connection between the data server and the mobile device as a client device; and

an authorization system authorizing a data transfer between the mobile device and the data server via the mobile data connection infrastructure and generating data representative of a mobile data access charge for the data transfer;

the data server and the authorization system interacting so that in a first mode of operation, the mobile device communicates with the data server by a data transfer which is charged to an account associated with that mobile device and the data server accesses the price database to offer the set of digital content items at a first set of prices, and in a second mode of operation, the mobile device communicates with the data server by a data transfer which is not charged to the account associated with the mobile device and the data server accesses the price database to offer the set of digital content items at a second set of prices, different to the first set of prices.

Further respective aspects and features of the invention are defined in the appended claims.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 is a schematic diagram of a mobile communications network;

FIG. 2 is a schematic diagram of a user equipment (UE);

FIG. 3 is a schematic diagram of a data communication process via the network of FIG. 1;

FIG. 4 schematically illustrates a SIM;

FIG. 5 schematically illustrates the structure of an IMSI (International Mobile Subscriber Identifier);

FIG. 6 is a schematic flowchart illustrating an authorization process between a UE and the network;

FIG. 7 is a schematic diagram of a mobile network showing arrangements for authorizing data access;

FIG. 8 is a schematic flowchart showing different data authorization techniques;

FIGS. 9 and 10 schematically illustrate certain steps of FIG. 8 in greater detail; and

FIG. 11 schematically illustrates an example system providing value-added functionality.

### DESCRIPTION OF THE PREFERRED EMBODIMENTS

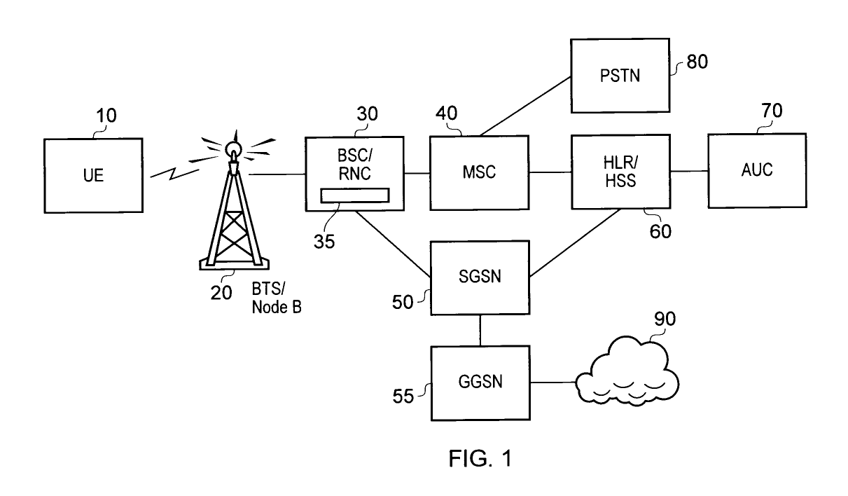

In the context of the present description, a “server” or “data server” may be considered as a general purpose computer comprising a processor, memory and/or other storage and input/output circuitry, running appropriate computer software. Referring now to FIG. 1, a basic mobile communications network (acting as a mobile data network providing a mobile data connection infrastructure in the context of the present techniques) comprises a user equipment (UE) 10, a base transceiver station (BTS) 20 (the equivalent function being referred to as “NodeB” in the context of a UMTS (Universal Mobile Telecommunications System) 3G (third generation) network, but only the acronym BTS will be used in this description), a base station controller/radio network controller (BSC/RNC) 30, a mobile switching centre (MSC) 40, a serving GPRS (general packet radio service) support node (SGSN) 50, a Gateway GPRS Support Node (GGSN) 55, a home location register (HLR) 60 and an authentication centre (AUC) 70. The MSC 40 connects to a public switched telephone network (PSTN) 80. The SGSN 50 connects to the Internet 90 via the GGSN 55.

In operation, the UE 10 connects via a wireless link to the BTS 20 which in turn is connected (usually by a wired or other point to point link) to the BSC/RNC 30. The BTS contains equipment for transmitting and receiving radio signals, antennas, and equipment for encrypting and decrypting communications with the BSC/RNC 30.

The BSC/RNC 30 controls the operation of the BTSs 20. Typically a BSC/RNC has many BTSs under its control. The BSC/RNC allocates radio channels and controls the handover of communication with a particular UE between different BTSs. The BSC/RNC 30 also multiplexes the many different low data rate communications with individual UEs into a higher data rate connection with the MSC 40.

The BSC/RNC 30 may have an associated packet control unit (PCU) 35 which carries out some of the functions of the BSC/RNC 30, but for packet data. The BSC/RNC, BTSs and PCU are sometimes collectively referred to as the BSS (base station subsystem) or, in 3G networks, the RAN (radio access network).

The MSC 40 is primarily responsible for routing voice calls, SMS (short messaging service, otherwise known as “text”) messages and circuit switched data. In respect of voice calls, the MSC 40 is able to route a call from a mobile UE to a fixed (landline) telephone using the PSTN 80. In general terms, the MSC is responsible for setting up and releasing the end-to-end connection, supervising hand-over between BSC/RNCs during a call and coordinating charging and account monitoring.

The HLR 60 (the generally equivalent function within 3G networks, as of LTE or “Long Term Evolution”, being known as the Home Subscriber Server or HSS) is a central database that contains details of each mobile phone subscriber that is authorized to use the core network. There can be several HLR/HSSs in existence, though each individual mobile subscriber identity can be associated only with one logical HLR/HSS (although this can span several physical nodes) at a time.

The HLR/HSSs store details of every SIM issued by a mobile phone operator. Each SIM has a unique identifier called an IMSI which is the primary key to each HLR/HSS record. The HLR/HSS also stores MSISDNs (Mobile Subscriber Integrated Services Digital Network Numbers) which represent the telephone numbers associated with the SIMs. A SIM has a primary MSISDN which is the number used for making and receiving voice calls and SMS messages, but it is possible for a SIM to have other secondary MSISDNs, for example being associated with fax or circuit switched data calls. An IMSI is also associated with details of services applicable to that user and call divert settings associated with an MSISDN. Note that in general, a SIM need not necessarily have an associated MSISDN if the SIM is used in the context of data access only.

The HLR/HSS 60 also connects to the AUC 70 whose function is to authenticate each SIM that attempts to connect to the network. This authentication process will be described in detail below. In brief, however, when the authentication process takes place (typically when a UE is first switched on), the UE sends its IMSI to the AUC via the HLR/HSS. The AUC replies with data derived from a so-called triplet of authentication data derived using a secure key known only to the AUC and to the SIM. This secure key is referred to as Ki. The SIM then sends a further reply to the AUC based on data from the triplet and, assuming the reply is in the correct form, the SIM (that is to say, that IMSI) is authorized for interaction with the network. The secure key Ki is securely stored on the SIM (which in the case of current SIMs takes place during manufacture), and is also securely replicated onto the AUC. These are the only copies of the secure key Ki. Ki is never transmitted between the AUC and the SIM, but instead is combined with the IMSI to produce a challenge and response for identification purposes and an encryption key called Kc for use in over-the-air communications.

The IMSI-Ki pair represents data defining a mobile identity, comprising an identification value (IMSI) which is transmitted to the mobile network as part of the network authorization procedure, and a secure key (Ki) which is not transmitted to the mobile network as part of the network authorization procedure, but from which the same card's network interface derives identification data and encryption/decryption key data for use in encryption and decryption of data communication over the mobile network.

Once authentication has taken place, the authorization triplet data is buffered at the SGSN 50. As mentioned, the triplet includes the encryption key Kc for use in encrypting data transfers between the UE and the network. The encryption/decryption process using Kc takes place at the currently active BSS/RAN applicable to that UE.

The Gateway GPRS Support Node (GGSN) is a main component of the GPRS network and handles matters such as IP (internet Protocol) address assignment and the like. The GGSN controls interaction between the GPRS network and external packetised networks such as the Internet 90. The GGSN checks if a user (being a recipient of a data transfer) is active, and if so, forwards the data to the respective SGSN serving that user. If the mobile user is inactive, the data is discarded. When a user initiates a data transfer, the packetised data is routed to the correct external network by the GGSN. This process will be described in further detail below.

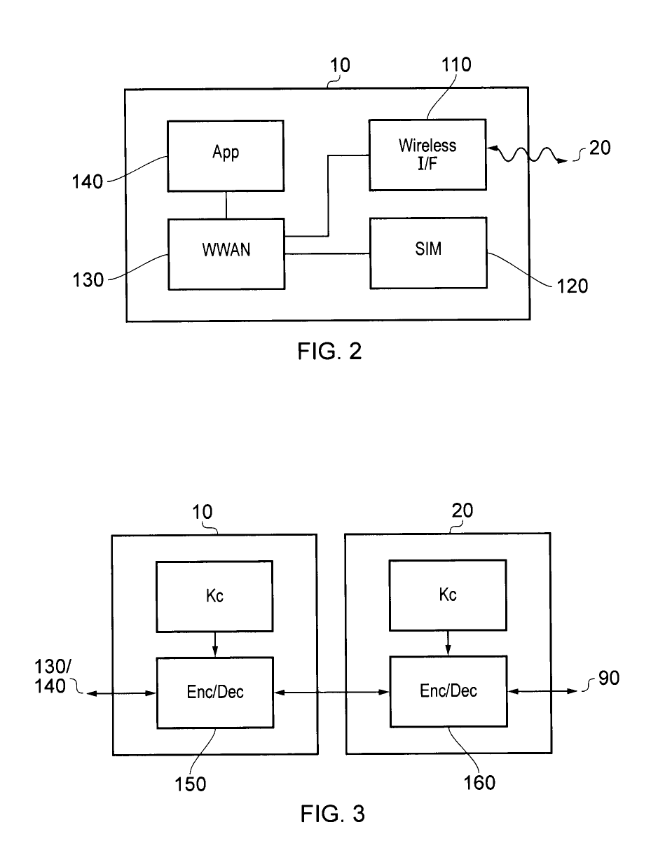

FIG. 2 is a schematic diagram of an example UE making use of data communications via the mobile network. The UE comprises a wireless interface 110 which provides the wireless communication with the BTS 20, a SIM 120, a wireless wide area network (WWAN) processor 130 and application software 140. It will be understood that the application software 140 communicates with a user interface such as a keyboard, a display, a touch screen and the like. For clarity, these items are not shown in FIG. 2.

The SIM acts as an identification module for securely providing a mobile identity to a mobile data network for use in identifying mobile equipment in which that identification module is installed.

Once the SIM of the UE 10 has been authorized, the operation involves the application software 140 initiating a message to be sent via the mobile network and passing that message to the WWAN processor 130 which formats it into a suitable form for transmission (for example as so-called IP data packets). Using a key Kc supplied by the SIM and an “A5” encryption algorithm, the WWAN processor 130 encrypts the data packets. The encryption key Kc used for encryption is the one that was established during the authorization process. The encrypted data is then passed from the WWAN processor 130 to the wireless interface 110 for transmission to the BTS 20. With regard to messages received from the network, data is transmitted from the BTS 20 to the UE and is received by the wireless interface 110. The data is decrypted by the WWAN processor using a key Kc supplied by the SIM 120, and is formatted (for example, depacketised) to be passed to the application software 140.

FIG. 3 is a schematic diagram of a data communication process via the network of FIG. 1. Here, the encryption and decryption processes are illustrated in a schematic form. At the UE 10, data passing to and from the application software 140 (via the WWAN processor 130) is subject to an encryption/decryption process 150 under the control of the key Kc. The encrypted data is passed via the mobile network to the BTS 20 where it is decrypted using an encryption/decryption process 160, again with reference to the key Kc. The clear (no longer encrypted) data is then transferred to and from the Internet 90. Accordingly, the data path between the SIM 120 and the BTS 20 carries data which is encrypted using the key Kc, whether that data is being transmitted to the UE or from the UE. Data outside of that encrypted path is clear data.

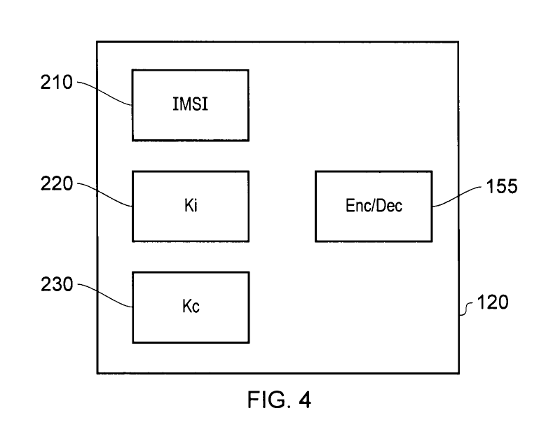

FIG. 4 schematically illustrates a SIM. The term “SIM” stands for “subscriber identification module”, and this identification function is carried out by virtue of the SIM carrying a unique IMSI and associated respective unique secure key Ki associated with a subscriber. The significant features of the SIM shown in FIG. 4 are as follows: secure storage (or at least a mobile identity storage controller for accessing memory, which would normally be on the SIM, which securely stores data defining the IMSI) for the IMSI 210, secure storage 220 (or at least a storage controller as above) holding the secure key Ki, memory storage 230 which holds the encryption key Kc and other temporary data and an encryption/decryption function 155 which also acts as a network interface for generating data derived from a mobile identity for transmission to a mobile network during a network authorization procedure, and for handling acknowledgement data received back from the mobile network indicating whether authorization was successful based on that mobile identity. The encryption/decryption function 155 carries out various different functions at different stages in operation. At least three encryption algorithms are provided. In brief, the two of these directly relating to the SIM are referred to as the A3 algorithm and the A8 algorithm. The A5 algorithm is used by the VVWAN processor 130 and will be described for comparison.

The A3 algorithm is a one-way function used to compute a signed response (SRES) during the authentication process. The generation and use of the SRES will be described further below. The A3 algorithm resides on the SIM and at the AUC.

The A5 algorithm is a two-way function used by the VVWAN processor 130 to encrypt and decrypt data that is being transmitted over the wireless interface, that is to say, it is the function which encrypts and decrypts data using the encryption/decryption key Kc described with reference to FIG. 3.

The A8 algorithm is a one way function used to generate the 64-bit key Kc. The generation of the key Kc will be described further below. The A8 algorithm also resides on the SIM and at the AUC.

Note that in 3G networks, an enhanced authentication algorithm (AKA—Authentication and Key Agreement) is used, and other algorithms than the A5 algorithm may be used. Other techniques, such as using a 128 bit CK (Ciphering Key) rather than the 64 bit Kc, may apply. Differences between 3G and 2G (second generation) networks are widely published, for example in http://www.3gpp.org/ftp/tsg_sa/wg3_security/_specs/33120-300.pdf

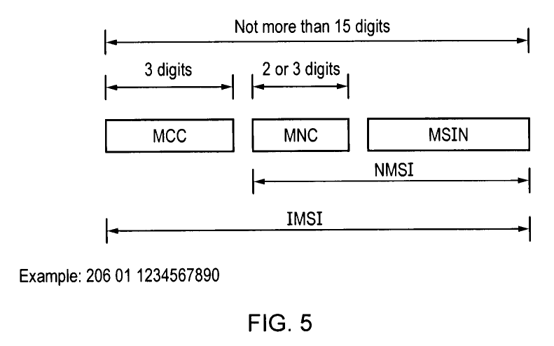

FIG. 5 schematically illustrates the format of an IMSI. The term “IMSI” stands for “international mobile subscriber identifier” and represents a unique identification associated with all users of the network. It is stored as a 64-bit field in secure storage 210 within the SIM and, when required, is sent by the UE to the network.

The maximum length of an IMSI is 15 decimal digits. The first three digits represent a mobile country code or MCC which identifies the country of origin of the subscriber's SIM. The next two or three digits represent a mobile network code or MNC which identifies a network company which provided (or possibly, which owns) the SIM. The final digits provide a mobile subscriber identification number or MSIN which is unique to a particular SIM within that network and that country defined by the MNC and MCC. The MNC and MSIN together provide a national mobile subscriber identification or NMSI.

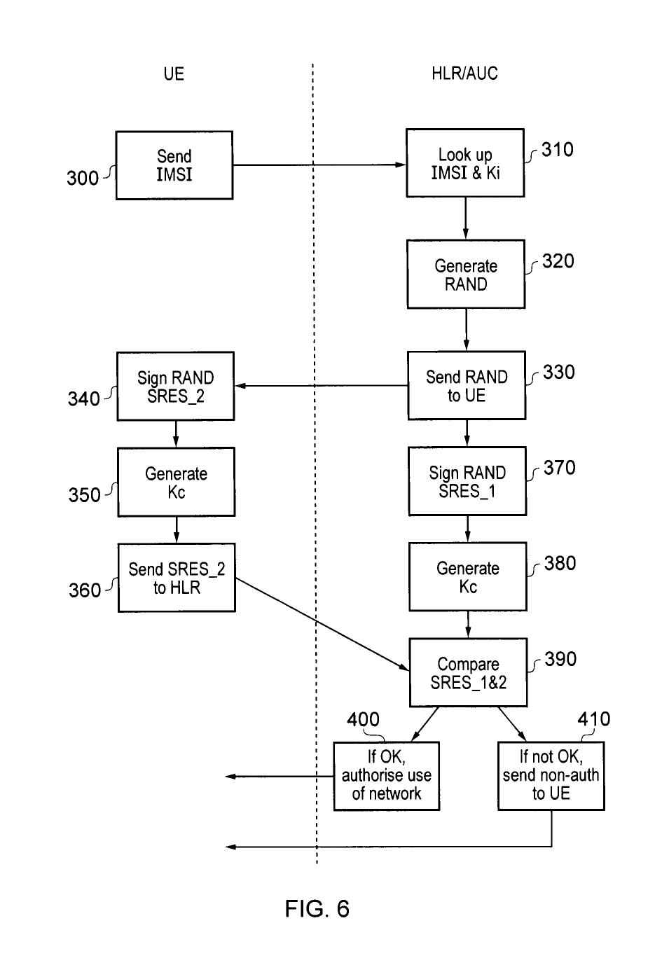

FIG. 6 is a schematic flowchart illustrating an authorization process between a UE and the network. Steps shown to the left of the vertical broken line are carried out at the UE 10 and steps shown to the right of the vertical line are carried out at the HLR/HSS 60 and/or the AUC 70.

At a step 300, the UE sends its IMSI to the network. In response to receipt of the IMSI, the HLR/HSS consults the AUC to request that the AUC generates an authorization triplet. The AUC 70 consults its database to find the secure key Ki at a step 310. At a step 320, the AUC generates a single-use random number, RAND. At a step 330, the AUC sends the random number RAND to the UE. The UE receives the random number RAND and, at a step 340, signs the number RAND with the SIM's secure key Ki to generate a signed response SRES_2.

The SIM then generates the encryption/decryption key Kc by applying the A8 algorithm to the number RAND and the secure key Ki, at a step 350. As mentioned above, the encryption/decryption key Kc is used later (subject to a successful authorization) for encrypting and decrypting communications via the mobile network during the present session. At a step 360, the UE sends the signed response SRES_2 back to the network.

Meanwhile, the AUC also generates a signed response SRES_1, by applying its stored version of the secure key Ki relating to that IMSI to the number RAND, at a step 370. As a step 380, the AUC generates the encryption/decryption key Kc by applying the A8 algorithm to the number RAND and the secure key Ki.

As a step 390, the AUC compares the signed responses SRES_1 and SRES_2. If the IMSI and Ki pair held by the SIM of the UE matches the IMSI and Ki pair held by the AUC, and bearing in mind that the versions of the A3 algorithm used by the SIM and the AUC are the same, then the signed responses SRES_1 and SRES_2 should be identical. If they are identical, then the SIM should be authorized for use during a current session on the network. Of course, authorization is not provided if an IMSI has already been authorized for a currently open session on the network. But assuming that the IMSI is not already authorized for a currently open session, and the two signed responses are identical, then at step 400, the SIM holding that IMSI is authorized to use the network and the encryption/decryption key Kc is passed to the SGSN 50. A message is sent by the HLR/HSS 60 to the UE 10 to indicate that authorization has been granted.

On the other hand, if either the IMSI is party to a currently open session that has already been authorized, or the two signed responses do not match, then the IMSI is not authorized for a connection session on the network. In this case, a non-authorization message is passed to the UE a step 410, and the version of the encryption/decryption key Kc generated by the AUC is not passed to the network for use in encrypting or decrypting communication with that UE.

Here, it is worth discussing “activation” and “registration” in respect of an IMSI.

At activation (first time entry in the HLR/HSS), an IMSI is activated in the HLR/HSS immediately, so the activation cost of [symbol] 1-10 is due straightaway as the cost is related to licensing and resource usage. This process takes place in respect of temporary-use IMSIs and is paid for by the manufacturer or MNO, for example. For paid-use of a SIM, the user must initiate a registration process. At this stage, the user registers the IMSI to use network services and establishes a one-to-one relationship between the IMSI (known to both the SIM and the MNO), the user's payment account and possibly also an identification of the UE in which the SIM is installed.

In practical terms, an example of a user's account might be represented by a set of data securely stored on a data carrier defining items such as one or more of the user's name, the user's UE, a contract or other arrangement between the user and a mobile network operator, and a manner of payment for mobile network charges by the user (such as a credit card or bank account number).

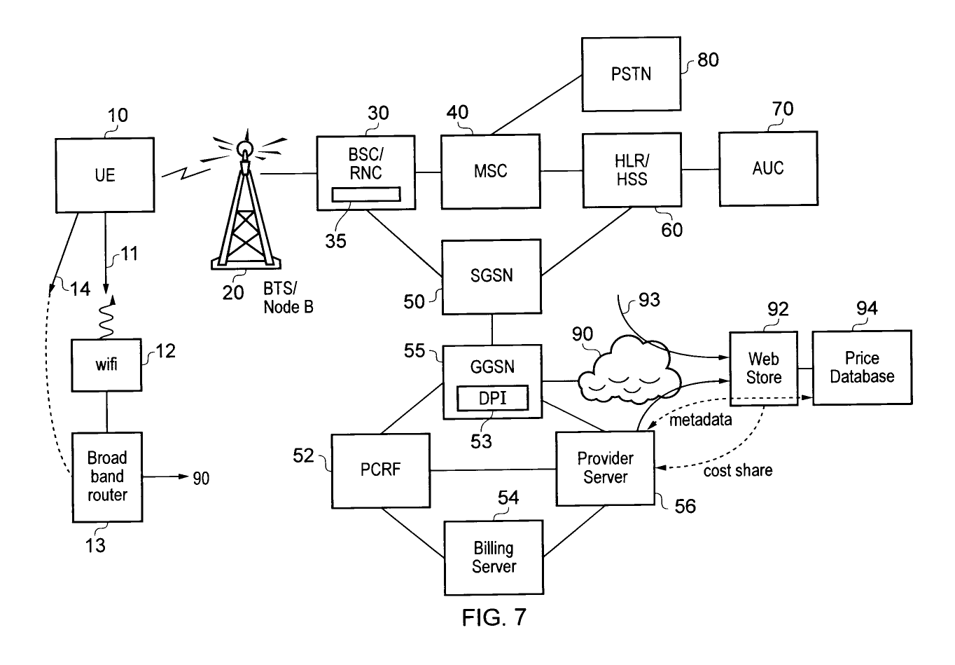

FIG. 7 is a schematic diagram of a mobile network showing arrangements for authorizing data access.

The system of FIG. 7 is based around that shown in FIG. 1, with some additional features being depicted. The substantive differences will now be described.

The GGSN 55 includes a function of so-called “deep packet inspection” (DPI) 53 and is associated with a policy control rating function (PCRF) 52, a provider server 56 and a billing server 54. Together, these items provide an authorization system.

A web store 92, being a data server having a function of offering a set of digital content items for sale, such that the digital content items may be downloaded by (digitally transferred to) a purchaser, is connected to the Internet connection 90. Examples of such content items might include text, executable applications, software code or configuration data, games, audio video, audio/video material, or electronic books delivered as one or more files or streams. A price database 94 is associated with the web store 92, so that the two items can be considered as a data server having a price database. The web store 92 is arranged to interact with client devices (such as the UE 10) by an independent Internet connection 93 or via the mobile network and the GGSN 55. The differences between these two modes of connection will be described below.

The UE 10 is capable of connecting to the web store 92 as a client via the mobile network. However, in this example, the UE also has the capability of a direct Internet connection 11 without using the mobile data network. Such a direct connection could be provided by, for example, a wireless network (Wi-Fi) connection 12 to a domestic broadband router 13 which in turn connects to the Internet 90. This is a common arrangement used in modern UE devices; typically, the UE can connect via the mobile data network when it is out of range of a Wi-Fi connection, but uses the Wi-Fi connection when it is available, because it is generally much cheaper for the user then the mobile data network connection. Although the broadband router 13 in FIG. 7 refers to as a domestic broadband router accessing a domestic Internet connection via ADSL (asynchronous digital subscriber loop) technology, an optical fibre connection or the like, it will be recognised that the Wi-Fi interface 12 and the router 13 may relate to a commercial Wi-Fi network (such as a network connection provided in an airport), to a corporate Wi-Fi network, to a hotel Wi-Fi network or the like. Indeed, various different options for providing a direct Internet connection at the UE are envisaged, such as a wired Ethernet connection 14 or a wired connection to the broadband router 13.

Therefore, the UE 10 has two different ways of connecting to the web store 92. One way is via the mobile data network and the other way is via a direct connection 93 using the independent Internet connection 12, 13, 14. This arrangement is shown here is an example of the two different manners of connecting to the web store 92. In fact, the techniques to be described would also operate in the case of a first type of UE which can only connect via the mobile data network and a second type of UE which can only connect via a separate Wi-Fi, Ethernet or similar connection.

The arrangements for charging for data access made by the UE 10 over the mobile data network will now be described.

A data transfer process between the UE and an Internet site such as the web store 92 is initiated (in this example) by packets of data sent from the UE 10 to the mobile data network. The packets contain routing information in known formats defining the destination of the packet transfer. The UE 10 sends such packets via the BTS 20 and the mobile data network to the GGSN 55.

The GGSN 55 analyses the received packets to establish their origin and destination. The GGSN achieves this by carrying out the so-called deep packet inspection process 53, which involves examining the contents (data content and/or header or routing data) of the data packets. The degree to which such inspection has to be carried out depends on the information which it is hoped to obtain. For example, data specifying the originating UE 10 and the ultimate destination (such as the web store 92) is provided at a high level within the data packet structure. Data indicating the type of data transfer being undertaken is found at a deeper level within the data packet structure. DPI is an established technique and is described in: http://en.wikipedia.org/wiki/Deep_packet_inspection

The GGSN 55 consults the PCRF 52 to determine policies associated with different types of data transfer. The policies relates to two main questions: firstly, whether a particular data communication should be allowed at all; and secondly, who (if anyone) should pay for the data communication. To allow these functions to be determined, the PCRF 52 communicates with the billing server 54 which handles information relating to user billing accounts associated with each UE 10.

The control process therefore operates as follows:

(a) The GGSN 55 establishes the identity of the UE 10 carrying out the communication and the destination and/or type of communication being undertaken.

(b) The GGSN consults the PCRF to determine whether that particular type of communication is allowable.

(c) The PCRF compares the information defining the type of communication with a database of policies to determine whether the communication can go ahead and whether the communication is chargeable.

(d) The PCRF sends a signal back to the GGSN to confirm whether the communication can go ahead. The PCRF sends data to the billing server 54 relating to charges to be imposed on the user account relating to that UE 10. The charging data may depend upon the total data volume and/or data transfer time involved in the communication; these details are provided by the GGSN to the PCRF to allow the appropriate data to be sent to the billing server 54.

Not all data transfers are chargeable to the user. For example, accessing the mobile data network's own website is often provided as a free service to subscribers to that mobile data network. In such cases, the destination of the data communication is detected by the GGSN and passed to the PCRF, which determines from its stored rules that communication with that destination is not to be charged to the user.

Another class of chargeable communication will now be discussed.

For certain destinations, as detected by the GGSN, data transfer is not free but neither is it chargeable to the user of the UE 10, or at least, not directly. Instead, such data transfer is paid for by a third party such as (in this example) the provider or manufacturer of the UE 10 or indeed, the provider of the web store 92. To enable this, the provider or manufacturer maintains the provider server 56.

The provider establishes a set of communication destinations and, optionally, a maximum data volume allowable in a certain period, for which the user will not be charged directly. This information is established as a set of policies held by (or accessed by) the PCRF. For example, the provider server 56 may provide such policies. By the PCRF, or the PCRF may access data storage held by the provider server 56 to retrieve such policies when needed.

When a current data transfer falls within the policies set by the provider, billing information for the user's account is not sent to the billing server 54. Billing information may be provided directly to the provider server 56, depending on the arrangement which the provider has with the mobile network operator. The provider server may pass on the charges to the user through a user account held with the provider, or the provider may absorb the costs for reasons to be discussed below.

The arrangement described above therefore allows for a further communication route with the web store 92. Earlier, two possibilities were discussed: firstly, that the UE could communicate via the mobile network and the GGSN and connect to the web store 92 via an Internet connection 90; and secondly, that the UE 10 could connect to the web store 92 by a separate Internet connection using the Wi-Fi interface 12 or wired interface 14, the broadband router 13 and a route 93. The third possibility available with the present configuration is that the UE 10 can communicate over the mobile network, with data being routed to the GGSN 55, to the provider server 56 and from there to the web store 92.

This third possible communication route allows the web store 92 to detect a different communication access and to alter its operation in response to that detection.

In particular, communication from the UE 10 over the mobile network and via the provider server 56 is not charged directly to the user. But because the web store 92 can detect that this communication route has been used (by its interaction with the provider server 56) the web store 92 can change the set of prices which it accesses from the price database 94 depending on whether this third communication route has been used.

So, for independent access to the web store 92 (for example, via the independent connection 93 having no associated access charges) a first set of prices may be used by the web store 92 from the price database 94. If, however, the web store 92 detects that a “free” access is being made by the UE 10 over the mobile network and via the provider server 56, then a different, higher, set of prices may be accessed from the price database 94. The price difference between the two sets of prices can be used to offset the cost of providing the “free” data access to the web store 92. For example, if the mobile network charges the provider server a certain cost per megabyte of data transferred over the mobile network, then a supplement may be added by the web store 92 to the download price of an item of digital content such that the supplement is equal to the data size of the item of digital content multiplied by the cost per megabyte applied by the mobile network. Of course, the supplemental price does not have to equal the data charge exactly; it could be more or less than the data charge, or may include an element of profit for the web store provider as well as covering the costs of the UE provider. But in general terms, the second set of prices (associated with “free” data access to the web store) will be higher than the first set of prices (associated with chargeable or non-mobile data access).

The cost difference can be implemented as a separate lookup table of costs in the price database 94, or as a schedule of supplemental costs in the price database 94 (to be added to base costs applicable to independent data access) or can be calculated when needed by multiplying the data size of a digital content item by a cost scaling factor and adding this to the base cost for that digital content item.

In addition to the above described price database key methods, other extra added-value implementation methods and functions are also provided in embodiments of the invention, such as one or more of the following features:
Linkage of the price database with the provider database (directly or via the web store as a secure proxy) to allow dynamic price adaptations to happen at the web store when instructed by provider database;
The provider database can consolidate and pass through to the price database dynamic mobile network specific information like price agreements, usage-based information, customer specific information and the like, allowing the variable prices associated with the price database to be established in response to actual network costs;
The provider database can in addition aggregate the above information with UE-specific data such as device type, device identification, location, quality of service (QoS) required for the data service used, and so on, which can provide better and more personalized pricing to be achieved by means of a dynamic and/or adaptable intelligent set of pricing rules in the price database;
The price database can trigger the provider database to change dynamically its policies, based on (for example) marketing needs, promotions, price changes and the like, which are managed in the price database;

The above techniques can be achieved by means of a metadata protocol which is established in advance (as between the provider database, the price database and optionally the UE).

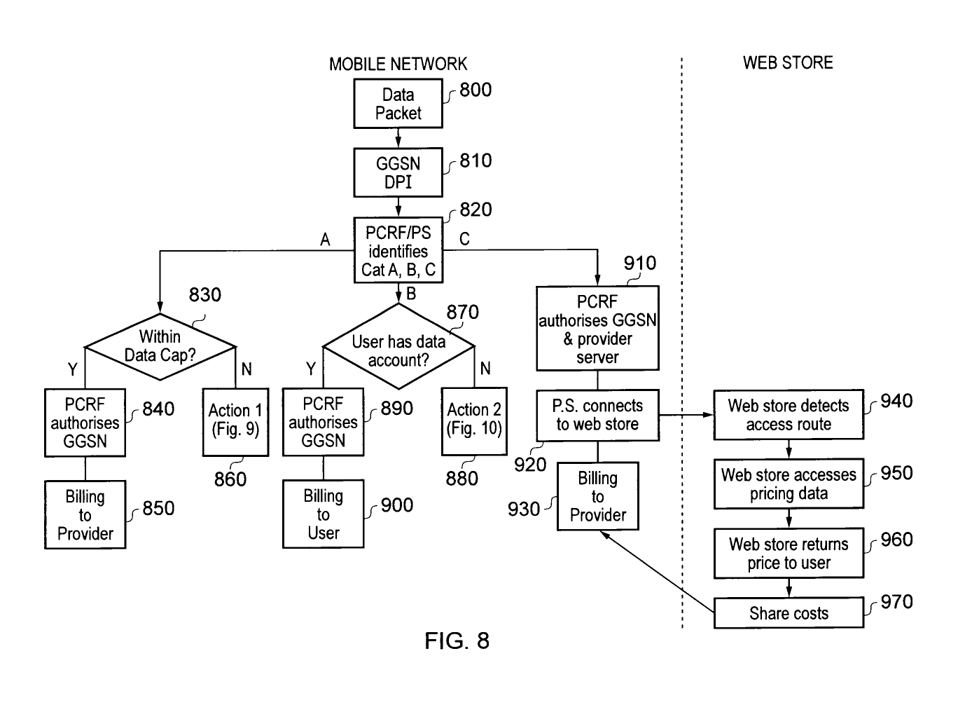

FIG. 8 is a schematic flow chart showing different data authorization techniques. Many of the steps shown in FIG. 8 relates to techniques which have been discussed in relation to FIG. 7 above.

Referring to FIG. 8, an incoming data packet 800 (for example, from the UE 10 communicated via the mobile network is subject to deep packet inspection by the GGSN 55 at a step 810. Using the information obtained during the packet inspection, the PCRF, in conjunction with the provider server, categorises the packet (and the subsequent data communication) at a step 820. The categories are referred to for simplicity in FIG. 8 as categories A, B and C.

Category A relates to data communication which is paid for by the provider of the UE 10 rather than being billed to the user. As mentioned above, such data communication might be subject to a data cap imposed by the provider server 56. Examples of communication within this category might be data access relating to a website provided by the provider server, or to software updates relating to the UE 10, or to gaming data relating to games running as software on the UE 10.

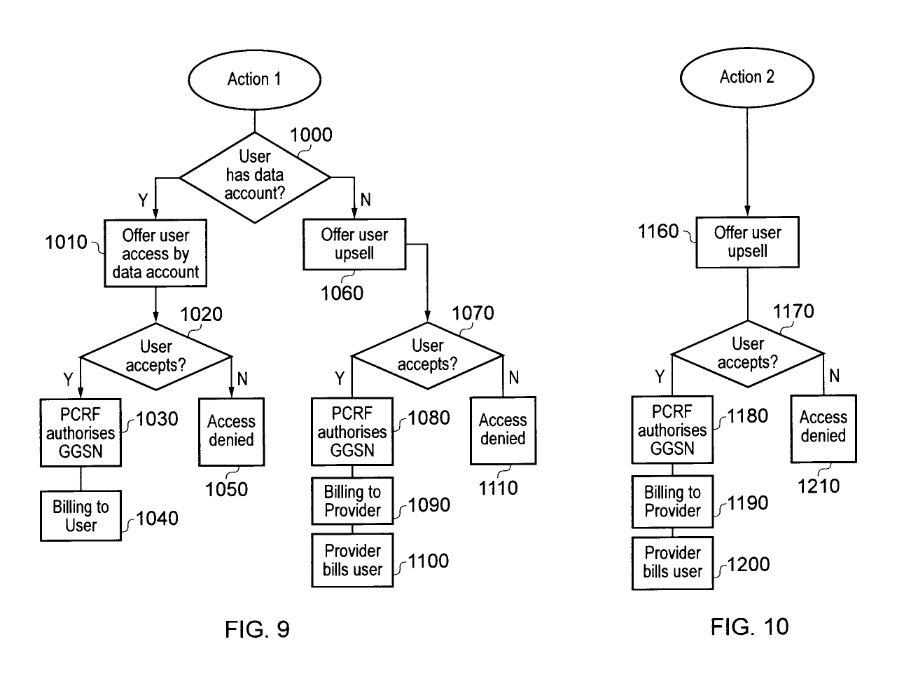

At a step 830, if the UE 10's data usage is within the data amount allowable under the arrangement with the provider server 56, then the PCRF authorises the GGSN to allow the data communication at a step 840 and the cost of the data communication (if any) is billed to the provider at a step 850. If, however, the UE 10's data usage has or is about to exceed the data amount allowable under the arrangement with the provider server 56, then at a step 860 control passes to “action 1” to be described below with reference to FIG. 9.

Category B relates to “regular” data access by the user, that is data which would normally be chargeable to the user and which is not covered by any special arrangements with the provider server.

At a step 870, the PCRF interacts with the billing server 54 to determine whether the user has a data account to which the costs of the current transfer may be applied. If the answer is no, then at a step 880 control passes to “action 2” in FIG. 10. However, if the user does have a valid and usable data account, then at a step 890 the PCRF authorises the GGSN to allow the data transfer, and the costs of the data transfer are billed to the user's account held with the billing server 54 at a step 900.

Category C relates to the type of data transfer discussed above in which the provider server 56 and the web store 92 cooperate to provide notionally free data access to the user, in the sense that the data access does not appear on the user's account with the mobile network. Instead, however, the costs of the data access may be recoverable, at least in part, by a surcharge on the price of digital content downloaded using such data access.

In category C, at a step 910 the PCRF, having detected by its interaction with the GGSN 55 and the provider server 56 that the current data access falls within category C, authorises the GGSN and the provider server to implement a data transfer route to the web store 92. As mentioned above, this involves the provider server 56 connecting to the web store 92 and forming part of the data route between the UE 10 and the web store 92, at a step 920. The costs of this data access are billed to the provider server at a step 930.

At a step 940, the web store 92 detects that access is being made via the provider server 56. This can be achieved as follows:

1. The GGSN detects (using the DPI and PCRF) that the traffic needs to be routed via the provider server rather than directly towards the public internet. This can be achieved, for example, by defining two different access point names (APNs) which can be applied to the current data communication for the two respective types of routing. An APN is a protocol to enable a device to access the Internet using the mobile phone network. APNs are described in http://en.wikipedia.org/wiki/Access_Point_Name

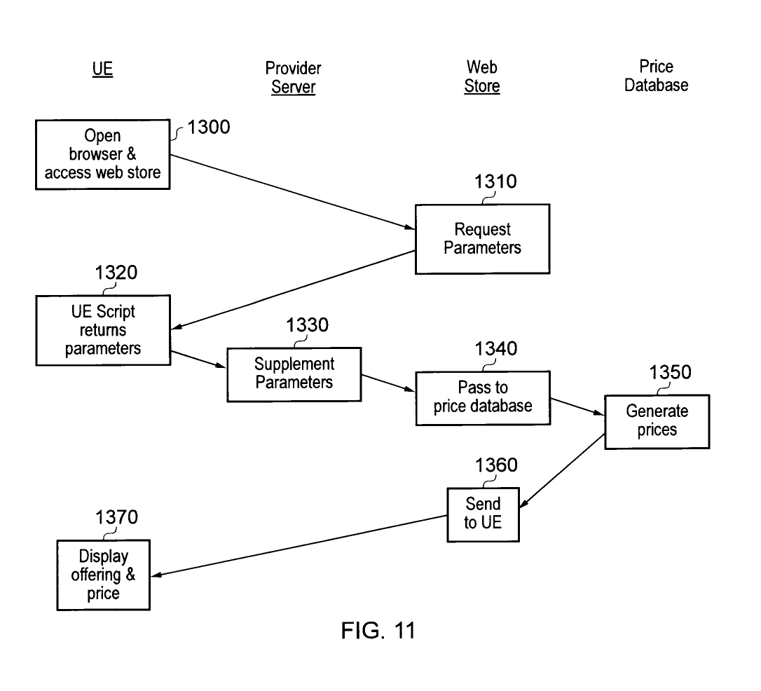

2. The traffic then is passed through the provider server 56, which, in embodiments of the invention, adds metadata such as that to be described with reference to FIG. 11;

3. The traffic then arrives at the web store via either the same physical network interface or either via a dedicated second network interface:
3a. In case of using the same physical interface the detection of this special traffic request can be done via IP source detection (the provider server has a known and potentially fixed IP address and/or a known and potentially fixed host name) and categorization
3b. In case if using a second physical interface, the categorization is achieved through detection that this second interface carries the traffic. Note that this might be the more secure option of the two, as this interface can be secured as a virtual private network (VPN) and/or two-way certification, or as a dedicated leased line.

In response, the web store 92 accesses pricing data at a step 950 which includes a supplement to cover, at least in part, the costs of the data access required to download each of the digital content items offered for sale. At a step 960 the web store returns the prices to the user of the UE 10. If the user goes ahead and purchases a digital content item, then that item is transferred to the UE 10 at the cost indicated by the web store 92 at the step 960. A proportion of the cost, for example a proportion of the supplemental cost added to the base cost of the digital content item, may be shared with the provider at a step 970.

Therefore, a mechanism is provided by which a user of a UE 10 can purchase digital content items without the transfer costs for those items appearing on the data access bill for that UE 10, by means of an automatically-implemented supplement or surcharge applied to the price of that digital content item.

FIGS. 9 and 10 schematically illustrate certain steps of FIG. 8 in greater detail. In particular, FIG. 9 relates to the action 1 referred to at the step 860 of FIG. 8, and FIG. 10 relates to the action 2 referred to at the step 880 of FIG. 8.

Referring to FIG. 9, this action is implemented if a category A data transfer has been identified at the step 820, but the data transfer is outside of the data allowance provided by the provider server 56.

At a step 1000, the PCRF and the billing server identify whether the user has a personal data account relating to that UE 10. If the answer is yes, then control passes to a step 1010 in which the user is offered data access by the personal data account rather than as part of a free data allocation provided by the provider server 56. If, at a step 1020, the user accepts this invitation, then at a step 1030 the PCRF authorises the GGSN to allow the data transfer and, at a step 1040, the cost of the data transfer is billed to the user's account. However, if at the step 1020 the user declines the invitation to use his personal data account then at a step 1050, the data access is denied.

If, at the step 1000, the user is found not to have a data account, then at a step 1060 the user is offered a so-called “upsell” which means the user is offered the chance to purchase further services from the provider. In particular, the user is offered the chance to pay for extra data access allowing the proposed category A data transfer to go ahead. This can be a one-off transaction, which therefore allows the user to make certain data accesses without having to establish his own account with the mobile network operator.

Accordingly, if at a step 1070 the user accepts the invitation to the upsell, then at a step 1080 the PCRF authorises the GGSN to allow the data transfer, and at a step 1090 the cost of the data access is billed to the provider server 56. At a step 1100 the provider bills the user for the amount agreed as part of the upsell offer. Of course, if at the step 1070, the user declines the upsell invitation, then at a step 1110, data access is denied.

The offers made to the user at the steps 1010 and 1060 can be implemented by various means. The UE 10 may have firmware or software already loaded onto it which, in response to packets of data from the provider server 56 which define the nature of the upsell and the costs involved, can display a user interface to the user of the UE 10 which firstly indicates the type and cost of the proposed upsell, and secondly provides a control for the user to indicate whether or not the user accepts the proposed upsell. As an alternative, when an offer is to be made to the user, the UE 10 can be diverted to a webpage, for example divided by the provider server 56, defining the offer and providing a control for the user to select his answer. A further alternative is that the user is sent a text (SMS) message to which the user must reply to indicate his acceptance of an offer of the type of steps 1010 and 1060.

FIG. 10 relates to the action 2 applicable if the user does not have the data account with a category B data transaction. Here, the user is offered an upsell at a step 1160, and the control passes through steps 1170, 1180, 1190, 1200 and 1210 which respectively correspond to the steps 1070, 1080, 1090, 1100 and 1110 of FIG. 9.

FIG. 11 schematically illustrates a possible implementation of a metadata mechanism to control dynamically the pricing and policy.

At a step 1300, the user of the UE 10 opens a web browser and initiates an access to the web store. Here it is assumed that the UE 10 has an active PDP (packet data protocol) context for internet access via the wireless network. PDP contexts are described in more detail in http://en.wikipedia.org/wiki/GPRS_Core_Network

In instances (with reference to FIGS. 8-10) in which access to the web store is achieved by means of routing via the provider server (for example, path C—FIG. 8) the steps carried out may include the following. Note that in these examples all communication is handled via the Provider Server. For clarity of the diagram, simple store and forward operations by the Provider Server are not explicitly shown, but data processing operations by the Provider Server are separately illustrated.

At a step 1310, the web store detects that the request for access (that is to say, an initiation of a data access) has come via the provider server route and therefore in the feedback towards the initial web store URL call made by the UE (such as, for example, http://www.companyX-web store.com) the web store sends back a request for more parameters of the UE so as to allow the pricing applicable to that UE to be displayed correctly. Note that this request is invisible to the user—the user just sees a normal web store welcome/home screen.

At a step 1320, the request triggers a local UE script to call a service which may either be pre-loaded at the UE or can be downloaded and installed at the first communication attempt with the web store which can retrieve the extra required parameters. These parameters are then retrieved. They could include, for example, the UE's location (detected using BTS address or triangulation or a global positioning system (GPS) detection), device type, current signal to noise ratio (SNR), expected service level (QoS). The parameters are UE's web client script (either in open format either in encrypted format) to be passed back to the web store. The web client script then adds these as parameters to the next request from the UE to the web store, for example using known techniques such as adding parameters within the web store's internet address or URL used for the data access:

http://www.companyX-web store.com/check_movies.php?par1=xxx&par2=yyy

where par1, par2 are parameters to be transferred, and xxx and yyy are their respective (possibly encrypted) values.

With reference to an encrypted format, the encryption could be done using known public/private key methods. For example, a public key on web store could be held in a database in a form which is one-to-one linked with a SNR value (and can be populated when devices are manufactured). A public key on the UE can be either pre-stored in the device or downloaded with first connection. A pre-defined algorithm on how this is transferred can be stored in the (downloaded) service which can be linked to the SNR of the UE. A private key can (for example) be the hashed time of the request, for example using a hashing algorithm known in both the service called by the UE script and at the web store. The time is known to both UE and web store. Other means of securely communicating are of course also possible; in some embodiments, a voucher code which is given physically to the device owner and known also at the web store at generation of the code could be used. In other embodiments, the so-called Extensible Authentication Protocol Method for GSM Subscriber Identity Module (EAP-SIM) could be used as a highly secure authentication method—this would require a local function call to the SIM on the UE and an extra so-called Radius server would be needed at the web store which connects to the HLR.

At the provider server, the parameters can be detected (for example by means of so-called state-full packet inspection, described at http://en.wikipedia.org/wiki/Stateful_firewall) and supplemented (at a step 1330) with extra parameters (for example, par3, par4, par5 and so on) having values relevant to the situation. For example, parameters from the current WWAN (wireless wide area network) MNO (mobile network operator) connection such as an MNO tariff change (which could be an overall tariff change or one relevant to current QoS or time of day or the like). This is an implementation option in which dynamic price changes from the MNO are sent to the provider server rather than to the price database, a feature which might be considered more appropriate from a security perspective.

At a step 1340, the parameters as received (which can include parameters provided by the UE and/or parameters provided by the Provider Server) are passed to the price database. The price database then uses the received parameters at a step 1350 to generate and send back applicable price information to the web store.

The pricing information used by the price database to modify the base price associated with a digital download offering can be made up as a combination of:
the size (in terms of data transfer) of the offered download product;
a normal wholesale price per MB related to the MNO price agreement, possibly being dependant on e.g. time of use, QoS etc;
customer specific information such as a categorization of importance of the customer (which could for example generate a discount);
specific promotions or sponsoring of own offer or of partners
device specific information; and/or
location based information.

The web store then (at a step 1360) uses these parameters to produce the final price the customer sees in the web store of each selectable service/content item. The UE's web client displays the results to the user at a step 1370.

In further embodiments of the invention, a path similar to the path C in FIG. 8 may be taken, but in a slightly different context to that of accessing a web store.

An example here might be the provision of traffic information data. There are existing known systems (such as that operated by the Tom-tom company in respect of a navigation product operable with the Apple iPhone) which aggregate location data gathered from the community of users to determine traffic speed and conditions. The traffic speed and condition information is then provided back to the community of users for use as part of their route-planning operation.

Under the current arrangements provided by this type of system, the data transfer relating to the traffic speed and condition information and to the location data sent to the navigation system provider are chargeable to the particular user of the handset (UE) concerned.

However, using an arrangement similar to the path C in FIG. 8, such data transfers could be detected by the PCRF and identified as “free” data transfers, which is to say that they are not chargeable to the user on the basis of the user's data access account with the MNO. Instead, they are chargeable to a provider server associated with the navigation system provider, and can be billed to the user indirectly as part of (for example) an annual subscription associated with the use of the particular navigation product.

While the description above has referred to SIMs, IMSIs and Ki keys, these terms are sometimes considered to relate to particular network standards or protocols. It will be appreciated that any type of identification module and mobile identity data fulfilling the basic requirements of identifying a node on a data network may be used in embodiments of the invention.

Although parts of the description have related to the use of physical SIMs having parameters defined in hardware, in embodiments of the invention a reconfigurable SIM may be used in place of any one of the SIMs discussed above. Such a reconfigurable SIM can store one or more IMSI-Ki pairs in a rewritable memory so as to be updated by a secure over-the-air (OTA) update or other secure transaction with a data provider. An example of such an arrangement is described in United Kingdom patent application number 1111355.2 filed on 4 Jul. 2011, the contents of which are hereby incorporated by reference in their entirety.

As discussed above, the data to identify the mobile data processing apparatus (UE) according to the first mobile identity can be provided from a non-removable identification module in the mobile data processing apparatus, and/or the data to identify the mobile data processing apparatus according to the second mobile identity can be provided from a user-removable identification module connectable to the mobile data processing apparatus. Alternatively, a software-implemented identification module can be configured to supply data to the wireless interface so as selectively to identify the mobile data processing apparatus to the mobile data network according to the first and/or the second mobile identity The identification modules may be SIMs (Subscriber Identification Modules). A mobile identity may comprise a subscriber identifier and a secret encryption key. The first set of data services (as provided via the embedded SIM's mobile identity) may comprise a service by which marketing data is transferred between the mobile data processing apparatus and a remote marketing server, and/or a service by which diagnostic data is transferred between the mobile data processing apparatus and a remote server.

The techniques described above may be implemented in hardware, software, programmable hardware such as application specific integrated circuits or field programmable gate arrays, or combinations of these. It will be understood that where the techniques are implemented, at least in part, by software or the like, then such software and providing media (such as non-transitory storage media) by which such software is provided are considered as embodiments of the invention.

Although the techniques have been described in respect of devices using data services, the UE could comprise one or more audio transducers and an audio data encoder and decoder; and at least some of the data transferred over the mobile data network could comprise encoded audio data handled by the audio data encoder and decoder. The embedded SIM arrangement could be suitable for services such as emergency distress beacons which (a) require to communicate very infrequently, and (b) do not necessarily need knowledge of their mobile telephony number (MSISDN).

It will be appreciated that although examples have been described with respect to particular mobile telecommunications standards, the invention is not limited to a particular standard, and is applicable to various arrangements in which an identification module carries a mobile identity. Examples of identification modules in other formats include the Universal Integrated Circuit Card (UICC) in UMTS, while the Removable User Identity Module (R-UIM) is used in some CDMA (code division multiple access) systems.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. A mobile data network comprising:
a data server configured to interact with client devices via the internet, the data server providing a price database and an online store by which a set of digital content items are offered for download at a respective set of prices provided by the price database;
a mobile device;
a mobile data connection infrastructure providing a data connection between the data server and the mobile device as a client device; and
an authorization system authorizing a data transfer between the mobile device and the data server via the mobile data connection infrastructure and generating data representative of a mobile data access charge for the data transfer;
the data server and the authorization system interacting so that in a first mode of operation, the mobile device communicates with the data server by a data transfer which is charged to an account associated with that mobile device and the data server accesses the price database to offer the set of digital content items at a first set of prices, and in a second mode of operation, the mobile device communicates with the data server by a data transfer which is not charged to the account associated with the mobile device and the data server accesses the price database to offer the set of digital content items at a second set of prices, different to the first set of prices.

2. A mobile data network according to claim 1, in which the second set of prices is higher than the first set of prices.

3. A mobile data network according to claim 2, in which the data server is configured to generate the second set of prices in response to parameter information defining the mobile device and/or parameters of the data connection between the data server and the mobile device.

4. A mobile data network according to claim 3, in which the data server is configured to request the parameter information from the mobile device.

5. A mobile data network according to claim 4, in which the data server is configured to request the parameter information from the mobile device in response to the initiation, by the mobile device, of a data exchange between the mobile device and the data server.

6. A mobile data network according to claim 5, in which the mobile device is configured to provide the parameter information as metadata within an internet address used by the mobile device to access the data server.

7. A mobile data network according to claim 4, in which the data server is configured to generate the second set of prices in response to one or more parameters selected from the list consisting of:
the data transfer size of an offered digital content item;
a price associated with the data transfer of that digital content item;
the current time of the data access;
a categorization of importance of the customer associated with the mobile device;
information defining the mobile device; and/or
information defining a current location of the mobile device.

8. A mobile data network according to claim 1, in which the authorization system is configured to detect at least a part of the content and/or header data of data packets sent by the mobile device.

9. A mobile data network according to claim 8, in which the authorization system is configured to detect whether a billing account exists with respect to the mobile device and, if not, to initiate an offer to the user to pay for a current data transfer.

10. A mobile data network according to claim 8, in which the authorization system is configured to detect whether a current data transfer relates to one of a set of data transfer destinations and, if so, to allow the mobile device to communicate with the data server by a data transfer which is not charged to an account associated with that mobile device.

11. A mobile data network according to claim 10, in which the authorization server is configured to detect whether a current data transfer would exceed a cap associated with data transfers to the set of data transfer destinations and, if so, to initiate an offer to the user of the mobile device to pay for the current data transfer.

12. A mobile data network comprising:
a data server configured to interact with client devices via the internet, the data server providing a price database and an online store by which a set of digital content items are offered for download at a respective set of prices provided by the price database;
a mobile data connection infrastructure providing a data connection between the data server and a currently connected mobile device as a client device; and
an authorization system authorizing a data transfer between the currently connected mobile device and the data server via the mobile data connection infrastructure and generating data representative of a mobile data access charge for the data transfer;
the data server and the authorization system interacting so that in a first mode of operation, the currently connected mobile device communicates with the data server by a data transfer which is charged to an account associated with that currently connected mobile device and the data server accesses the price database to offer the set of digital content items at a first set of prices, and in a second mode of operation, the currently connected mobile device communicates with the data server by a data transfer which is not charged to the account associated with the currently connected mobile device and the data server accesses the price database to offer the set of digital content items at a second set of prices, different to the first set of prices.

13. A mobile device connectable as a client device to a mobile data network having a mobile data connection infrastructure to allow connection between the mobile device and a data server configured to interact with client devices, the data server providing a price database and an online store by which a set of digital content items are offered for download at a respective set of prices provided by the price database; the mobile device comprising:
a data sender configured to send data to the data server defining parameters of the mobile device and/or parameters of a data connection between the mobile device and the data server.

14. A mobile data access method comprising:
a data server interacting with client devices via the internet to provide an online store by which a set of digital content items are offered for download at a respective set of prices provided by a price database;
an authorization system authorizing a data transfer between a mobile device and the data server via a mobile data connection infrastructure and generating data representative of a mobile data access charge for the data transfer; and
the data server and the authorization system interacting so that in a first mode of operation, the mobile device communicates with the data server by a data transfer which is charged to an account associated with that mobile device and the data server accesses the price database to offer the set of digital content items at a first set or prices, and in a second mode of operation, the mobile device communicates with the data server by a data transfer which is not charged to the account associated with the mobile device and the data server accesses the price database to offer the set of digital content items at a second set of prices, different to the first set of prices.

15. A non-transitory storage medium carrying computer software which, when executed by a computer, causes the computer to implement the method of claim 14.

16. A mobile data access method comprising:
a data server interacting with client devices via the internet to provide an online store by which a set of digital content items are offered for download at a respective set of prices provided by a price database;
an authorization system authorizing a data transfer between a mobile device and the data server via a mobile data connection infrastructure and generating data representative of a mobile data access charge for the data transfer; and
the data server and the authorization system interacting so that in a first mode of operation in which the mobile device is authorized to communicate with the data server by a data transfer which is charged to an account associated with that mobile device, the data server accesses the price database to offer the set of digital content items at a first set or prices, and in a second mode of operation in which the mobile device is authorized to communicate with the data server by a data transfer which is not charged to the account associated with the mobile device, the data server accesses the price database to offer the set of digital content items at a second set of prices, different to the first set of prices.

17. A non-transitory storage medium carrying computer software which, when executed by a computer, causes the computer to implement the method of claim 16.

18. A method of operation of a mobile device connectable as a client device to a mobile data network having a mobile data connection infrastructure to allow connection between the mobile device and a data server configured to interact with client devices, the data server providing a price database and an online store by which a set of digital content items are offered for download at a respective set of prices provided by the price database;
the method comprising:
the mobile device sending data to the data server defining parameters of the mobile device and/or parameters of a data connection between the mobile device and the data server.

19. A non-transitory storage medium carrying computer software which, when executed by a computer, causes the computer to implement the method of claim 18.

20. A mobile data network comprising:
a data server configured to interact with client devices via the internet;
a mobile device;
a mobile data connection infrastructure providing a data connection between the data server and the mobile device as a client device; and
an authorization system authorizing a data transfer between the mobile device and the data server via the mobile data connection infrastructure and generating data representative of a mobile data access charge for the data transfer;
the data server and the authorization system interacting so that in a first mode of operation, the mobile device communicates with the data server by a data transfer which is charged to an account associated with that mobile device, and in a second mode of operation, the mobile device communicates with the data server by a data transfer which is not charged to the account associated with the mobile device.
